(19) United States
(12) Patent Application Publication
(10) Pub. No.: US 2020/0257847 A1
(43) Pub. Date: Aug. 13, 2020

(54) SYSTEM AND METHOD FOR USING ARTIFICIAL INTELLIGENCE TO DEDUCE THE STRUCTURE OF PDF DOCUMENTS

(71) Applicant: NetCentric Technologies Inc. dba CommonLook, Arlington, VA (US)

(72) Inventor: Ferass El-Rayes, Kanata (CA)

(21) Appl. No.: 16/783,906

(22) Filed: Feb. 6, 2020

Related U.S. Application Data
(60) Provisional application No. 62/802,328, filed on Feb. 7, 2019.

(51) Int. Cl. G06F 40/117; G06N 20/00; G06N 5/04; G06F 40/258

(52) U.S. Cl. CPC G06F 40/117; G06F 40/258; G06N 5/04; G06N 20/00

(57) ABSTRACT

An architecture for generating accessible documents divides content into blocks and sub-blocks and uses multiple Artificial Intelligence or other machine learning processes to predict the structure type and additional Meta data in PDF documents. The processes base their predictions on user selectable models generated from previously learned well-tagged documents using different classification algorithms and metrics.

### CROSS-REFERENCE TO RELATED APPLICATIONS

This application claims priority to U.S. Patent Application 62/802,328, filed Feb. 7, 2019, incorporated herein by reference as if expressly set forth.

### STATEMENT REGARDING FEDERALLY SPONSORED RESEARCH OR DEVELOPMENT

None.

### FIELD

The technology herein relates to Computer Science, Artificial Intelligence, Deep Learning, Machine Learning, Digital documents, and Accessibility.

### BACKGROUND

The baby boomer phenomenon and other factors such as higher quality medical care has resulted in an increased percentage of older people in the general population. For example, approximately 15% of the US population was over 65 years of age in 2016. 27% of men and 15% of women aged 65 and older are expected to be in the labor force by 2022. Meanwhile, the average life expectancy in the United States was 79 in 2013. With statistics showing an increasing number of older Americans, the need for assistive technologies can be expected to increase significantly.

Several standards exist to regulate the generation of digital documents. The Web Content Accessibility Group (WCAG) of the World Wide Web Consortium (W3C) has developed WCAG 2.0 which many governments have either adopted (Section 508) or based their own standards on (The Health and Human Services Standard (HHS)). The International Standards Organization (the owner of the PDF format) has also developed Portable Document Format for Universal Accessibility (PDF/UA, or ISO 14289-1).

These standards restrict certain features and require implementing others in documents to facilitate accessibility to a wide variety of disabilities and also to ensure accessibility to the widest types of devices possible (e.g., Tables, Smart Phones, etc.).

Some of the requirements for accessible document generation include:
Determining the correct structure of the document (also called tags). This is a complex problem, as some of the challenges include
“guessing” which parts of the document are:
   Tables vs. multi-column formats.
   Header cells vs. data cells.
   Headings and heading levels
   Lists and nested lists
   References and foot/end notes
   Artifacts (not part of the real content of the document, for example, pagination, running headers and footers, watermarks, . . . )
Providing Alternate description of non-textual elements including:
   Figures
   Links
   Form fields
Providing other meta data including:
   Document meta data
      Author
      Subject
      Keywords
      Title
   Tag meta data
      Header cell scope (column, row or both)
      Headers cells assigned to data cells via IDs.
      ListNumbering

Automated processes that attempt to determine this information after the document has been generated have been generally error prone.

With formats such as PDF, where structure is completely separate from presentation and layout, this is more of a problem as the majority of documents tend to be created without structure at all. Also, documents can be created without reliable Unicode mapping and missing spaces between words or between lines for a consumer of the PDF structure.

Features in products today exist to attempt to deduce or guess the structure of a document from the way it is laid out on the page (for example, Adobe's Add Tags to Document feature applies pattern recognition to come up with this structure). However, this method typically fails for any document containing relatively complex structures (e.g., tables, lists).

Other approaches have tried to map documents to existing templates containing structural information.

### PRACTICAL APPLICATION

Structure tags are the basis of document accessibility. A structured document enables assistive technologies (screen readers, refreshable Braille displays and others) process and navigate through documents. It also allows repurposing for data extraction, search, format conversion and many other applications.

People and devices are able to navigate the document using headings and heading levels, are able to distinguish between table data cells and table header cells and associate the data cells with their corresponding header cells, navigate lists and nested lists, process tables of content, and so on.

### BRIEF DESCRIPTION OF THE DRAWINGS

The following detailed description of exemplary non-limiting illustrative embodiments is to be read in conjunction with the drawings of which:

FIG. 1 shows an example non-limiting overall system;

FIG. 2 shows an example non-limiting scenario for model learning from a number of files;

FIG. 3 shows an example non-limiting scenario for generating models;

FIG. 4 shows an example non-limiting scenario of tagging a document;

FIG. 5 shows an example non-limiting dividing a page into blocks;

FIG. 6 shows an example non-limiting method for matching figures; and

FIG. 7 is a block diagram of an example computer system that performs the steps, processes and functions of FIGS. 1-6 under control of instructions stored in non-transitory memory.

### DETAILED DESCRIPTION OF PREFERRED EMBODIMENTS

Example non-limiting embodiments provide methods and systems for generating an accessible file or document such as a PDF file comprising: (a) generating a model in response to learning from a set of similar, well tagged PDF files and user input to select the metrics to be used for prediction in that model. Images within these documents are rendered and their features are extracted and saved in a repository along with any provided alternative text; (b) Previously tagged or untagged files are opened and are divided into blocks. Blocks are then checked for well-known patterns and subdivided accordingly into sub-blocks and an AI tag predictor module uses the generated model to predict the type of tag (providing additional Meta data as required by accessibility standards); (c) Heading levels for heading tags may be adjusted to ensure compliance with accessibility standards; (d) A Figure AI module, in which figures are compared to other figures stored in the database and if a good match is found, it is assigned Meta data (for example Alternative Text) provided in the database; and (e) A text tag Meta data AI module which determines other Meta data that may be attached to the tag. For example, language, alternative text, actual text or expansion text. This is based on the textual content of the tag in addition to the text case (all caps, mixed case . . . etc.)

The model may be generated in response to varying the metrics used and the algorithms used for classification.

The features of the images may be extracted for comparison with new images in documents.

The documents may be divided into blocks and sub-blocks.

The order of the pattern matching may be Table, Figure, TOC, List, Index then other tags.

The heading level is adjusted to ensure compliance with accessibility standards.

The figures are matched to those stored in the repository and the best match (above a certain user-adjustable threshold) is selected and the corresponding Meta data is set for the figure.

Additional Meta data may be assigned to the tag.

Multiple repositories of learning data of similar documents (e.g., documents derived from the same template or similar templates) can be created, stored and then utilized to increase the accuracy of tagging.

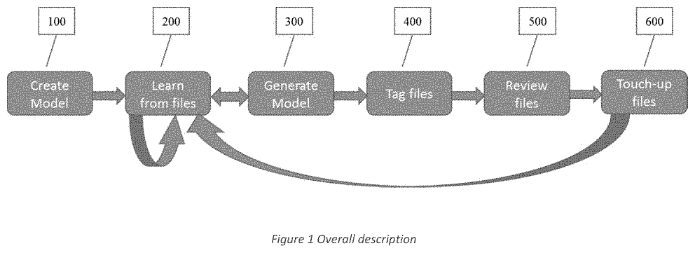

FIG. 1 shows an example non-limiting overall system and process that generates models by learning certain features and mapping them to tags based on a well-tagged sample of documents. These models are then used to determine how future documents will be tagged. The generated file may then be reviewed, corrected (if necessary) and then sent back to the system to be learned so that it is added to the data that determines future tags.

As shown in FIG. 1, a first step 100 creates a model. Such model creation 100 can involve training an artificial intelligence model such as a deep neural network using a collection of PDF documents so the model machine learns from the files (block 200). The resulting model is then generated (block 300). The resulting model is used to analyze and classify structures of a file and generate tags for those structures (block 400). An optional automatic or manual review step (block 500) determines whether the tags generated by the automatic classification are correct. The results of the review step may be used to touch up the files and in particular the tags generated for the files (block 600).

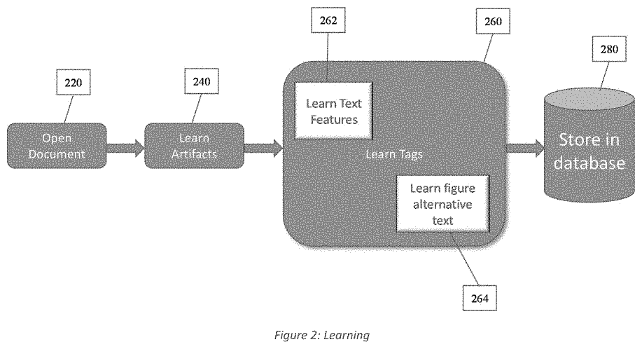

FIG. 2 shows an example non-limiting machine learning process in more detail. A set of well-tagged PDF documents are opened (220) and their tags (240) and artifacts (230) are enumerated. In one non-limiting example, numeration of the tags may involve determining tag content, position, layout, style, etc. Depending on the tag type, features (metrics) such as font size, font color, formatting (bold, italic) and background color are collected for “text” tags (262). Other features are collected for Figures (264) including a binary representation of the image along with its alternative text. These features are then saved into a repository (for example a database (280)).

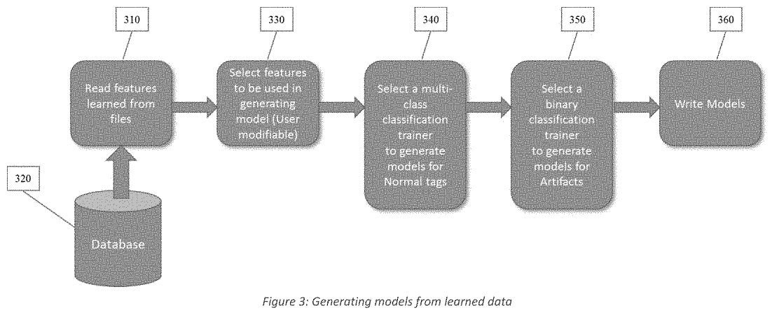

After a suitable number of documents have been learned, a machine learning model is generated as shown in FIG. 3. Metrics (310) are read from the database (320). In one example non-limiting embodiment, users may choose a subset of the metrics collected to generate the models for Artifacts and normal tags (330). For example, the classifier may be directed to include or ignores certain metrics related to tag content, position, layout and style. Users may also select a tag classification algorithm for classifying “normal” tags from any of several suitable multi-class algorithms (340) and may select an artifact classification algorithm from any of several different binary algorithms (350) for classifying artifacts. In the example non-limiting embodiment, the resulting models generated by block 360 includes both one or more models for “normal” tags and one or more models for artifacts.

The classifier writes the models (360) to generate the equations or neural network coefficients used for predictions.

The ability to change the metrics and algorithms used for generating models allows users to experiment with different cases and use the model that provides the best predictions. Alternatively or in addition, different models can be trained using different training sets to provide different prediction results. For example, one particular user application might involve a certain kind of document such as a directory. The model for that user could be trained using well-tagged directory documents. Other applications could involve different kinds of documents that can benefit from being trained using other, different collections of well-tagged documents.

The system shown in FIG. 3 may be executed on a conventional computing system including for example a CPU, a GPU, one or more memories, a mass storage device used to store the database 320 and the written models 360, and a user interface including for example a display and one or more user input devices. Such computing system could be cloud based in some cases if desired. Blocks 330, 340, 350 may be performed by the CPU in response to user inputs provided via the user input device(s) and/or based on a settings file stored in a storage device. The “Write Models” block 360 may be performed by a conventional machine learning/artificial intelligence engine such as a deep neural network or other machine learning development system that executes on the CPU and/or the GPU.

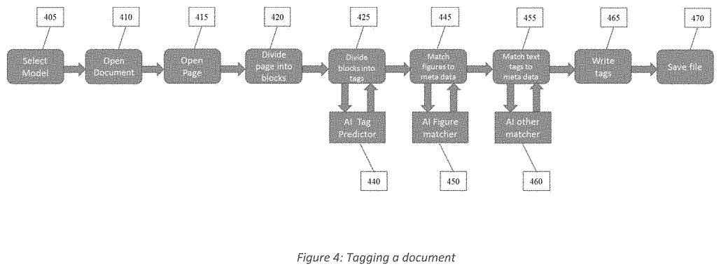

Example non-limiting tagging of documents is shown in FIG. 4. A model is first selected (405) and a document is opened (410). The input document may be previously tagged, or completely untagged, or partially tagged. A page is opened (415) and all elements within the page are sorted before the contents of the page are divided into blocks and sub-blocks (420). Such structural subdivision may be performed in different ways depending on the particular implementation. Each block is then divided into potential tags (425) and the predicting equations or other prediction elements of a trained model are used to determine first if it is an artifact or not, and then the tag type. The tags are then written to the document (465) and the document is saved (470). Blocks 405 to 470 may be performed using the same computing system used for training the models, or it may be performed using a different local, cloud-based or other computing system including a CPU, a GPU, memory, mass storage device(s), display(s) and user input device(s).

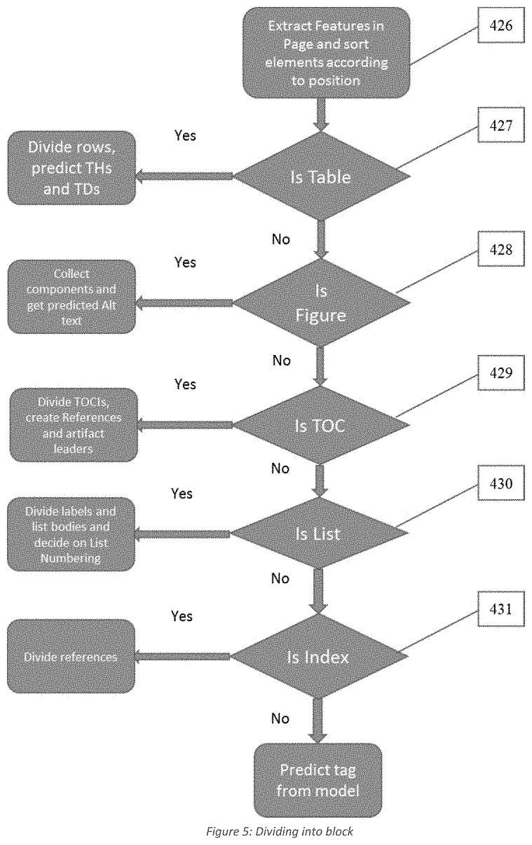

FIG. 5 shows an example non-limiting algorithm for dividing sorted elements in a page into blocks. Once elements in a page have been collected and sorted according to their position (426), we check if there is a table (442). If so, elements are divided into rows and columns (cells) and then the AI tag predictor may be used to determine whether tags are table data cell (TDs) or table header cells (THs).

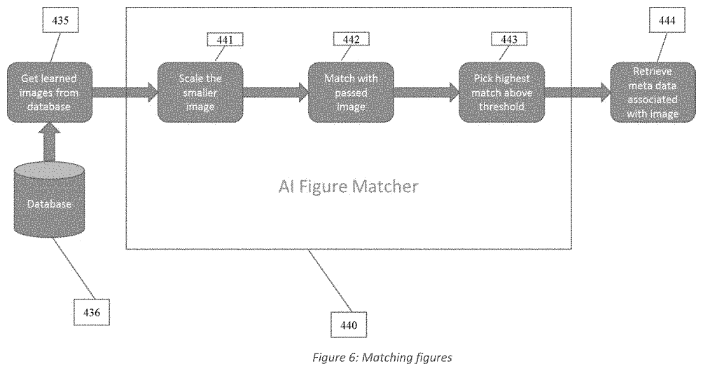

If the block is not a table, we check if it is a Figure (428). If it is, the figure is rendered and is compared with those stored in the database in the same model as shown in FIG. 6. Images are compared by resizing the smaller image using cubic interpolation (441) and then matching the two images using the Normal Coefficient method (442). The image with the highest score (above a user selectable threshold) is selected (443). Additional Meta data stored for the image with highest score (for example alternative text) are copied to the newly created figure.

If the block is not a figure, we check if it is a Table of Contents (TOC) (429). If it is, contents are divided into Table of Contents Items (TOCIs) and each TOCI would contain a Reference. Also, leaders are artifacted.

If the block is not a TOC, we check if it is a List (430). If it is, it is divided into List Items (LIs) and each LI is divided into a Label (Lbl) and a List Body (LBody). We also check if the label corresponds to one of the values defined by the PDF standard (ISO 32000). If it does, the value of ListNumbering is set to the corresponding value. If not, the value is set to None (as is recommended by the PDF standard and relevant accessibility standards).

If the block is not a List, we check if it is an Index (431). If it is, it is divided into a number of References (with Leaders artifacted as well).

FIG. 4 shows that the parameters are sent to the AI Tag predictor module (440) that uses the model to predict the type of tag.

While the algorithm above is described based on the specified order (e.g., if the block is not a table we check for figure, if not for TOC, etc.) other orders can be successfully applied. Furthermore, different types of documents or other files may involve different kinds of checks as appropriate to the structure of that particular document or other file.

When a tag is predicted to be a Heading, an algorithm is used to possibly adjust the Heading level to ensure compliance with accessibility standards.

Tags (along with its other metrics) (455) are then passed to another AI module (460) that detects whether additional metrics should be attached to the tag (for example, alternative text, actual text, language . . . etc.).

Note that in all cases in one example non-limiting embodiment, if we detect a Link Annotation, a link tag is created to include the link along with its textual description. This description is also copied to the Contents attribute of the annotation and the Alternative Text of the Link tag. The link will be appropriately nested within its context (e.g., Paragraph, or Reference in TOCIs or Indices).

Once the file is fully tagged, the file is saved (470).

Users may review the file (480) for any non-optimal values for tags or attributes. In one example non-limiting embodiment, the file may then be corrected and then sent back to the AI learning module and the model regenerated to improve future predictions, providing iterative machine learning.

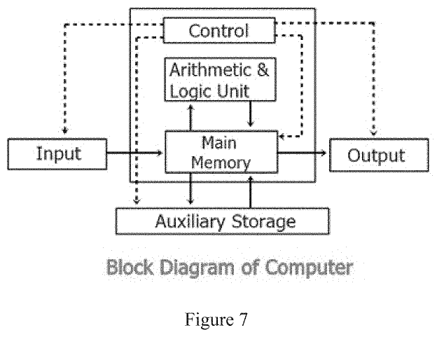

FIG. 7 shows an example computer system that can be used to perform the operations discussed above. The example computer system comprises an input subsystem, and output subsystem, and a processor (shown as the solid central box) comprising a control unit, and ALU and a non-transitory main memory. The computer system main memory can be backed by an auxiliary memory such as a NAND or NOR flash memory, a semiconductor memory, a magnetic disk memory, or other type of memory. In some embodiments, the processor can further include one or more GPUs, neural networks, parallel processors, multithreaded processors, etc.

In the example shown, the auxiliary memory may be used to store the predictive model discussed above. In some example implementations, the predictive model is generated at an earlier time using the same or different computer system, and is stored in the memory for use at run time during analysis of current documents inputted via the input subsystem shown. The processor processes the documents as described above; and outputs, via output subsystem, tags, metadata, and modified versions of the documents as described above. Such outputted information may be stored in auxiliary memory, communicated via a digital network to a server in the cloud and/or to a peer computing system, displayed on a display device, printed on a printing device, or otherwise provided/stored/communicated.

The invention is not to be limited by the disclosed embodiments, but on contrary, is intended to be covered within the spirit and scope of the claims.

1. A system for generating accessible documents, the system being of the type that uses a predictive model generated in response to learning from a set of tagged documents, including rendering images within the tagged documents, extracting features from the tagged documents and saving the extracted features along with any provided alternative text in a repository, the system comprising:
a memory configured to store the repository; and
at least one processor configured to perform operations comprising:
dividing a previously tagged, untagged or partially tagged document into blocks;
checking the blocks for well-known patterns to subdivide the blocks into sub-blocks;
using an artificial intelligence tag predictor to predict, based at least in part on the predictive model, a type of tag for the document;
providing meta data for the document to meet accessibility standards;
adjusting heading levels for heading tags to provide compliance with accessibility standards;
using an image artificial intelligence and/or machine learning based algorithm to compare images of said document to other images and if a match is found, assigning meta data to said images; and
using a text tag meta data artificial intelligence and/or machine learning based algorithm to determine other meta data for attachment to tags of said document.

2. A method for generating an accessible PDF file comprising:
(a) generating a model in response to learning from a set of similar, well tagged PDF files and user input to select metrics to be used for prediction in the model, including rendering images within the well tagged PDF files, extracting features from the well tagged PDF documents and saving the extracted features in a repository along with any provided alternative text;
(b) opening previously tagged, untagged or partially tagged files and dividing the previously tagged, untagged or partially tagged files into blocks;
(c) checking blocks for well-known patterns to subdivide the blocks into sub-blocks;
(d) using an artificial intelligence tag predictor to predict, based at least in part on the generated model, the type of tag including providing additional meta data as required by accessibility standards;
(e) adjusting heading levels for heading tags to ensure compliance with accessibility standards;
(f) using a figure artificial intelligence and/or machine learning based algorithm to compare figures to other figures stored in the database and if a match is found, assigning meta data provided in the database; and
(g) using a text tag meta data artificial intelligence and/or machine learning based algorithm to determine other meta data that may be attached to the tag.

3. The method of claim 2 wherein the text tag meta data algorithm uses language, alternative text, actual text or expansion text based on the textual content of the tag in addition to the text case such has all caps or mixed case.

4. The method of claim 2 wherein the model is generated in response to varying the metrics used and the algorithms used for classification.

5. The method of claim 2 wherein the features of the images are extracted for comparison with new images in documents.

6. The method of claim 2 wherein the documents are divided into blocks and sub-blocks.

7. The method of claim 6 wherein the order of the pattern matching is Table, Figure, TOC, List, Index then other tags.

8. The method of claim 2 wherein the heading level is adjusted to ensure compliance with accessibility standards.

9. The method of claim 2 wherein the figures are matched to those stored in the repository and the best match (above a certain user-adjustable threshold) is selected and the corresponding Meta data is set for the figure.

10. The method in claim 2 wherein additional Meta data is assigned to the tag.

11. The method of claim 2 wherein multiple repositories of learning data of documents derived from the same template or similar templates can be created, stored and then utilized to increase the accuracy of tagging.

12. A system for generating an accessible file comprising:
(a) generating a model in response to machine learning;
(b) enabling a user to select metrics to be used for prediction in the model;
(c) using an artificial intelligence tag predictor to predict, based at least in part on the generated model, a type of tag; and
(d) assigning metadata to the tag.
